(19) United States
(12) Patent Application Publication
(10) Pub. No.: US 2008/0092400 A1
(43) Pub. Date: Apr. 24, 2008

(54) Hacksaw

(75) Inventors: Michael Circosta, New York, NY (US); Conor McNamara, Brooklyn, NY (US); John Jay Sinisi, Warminster, PA (US); Jonathan A. Hughes, Moorestown, NJ (US)

Correspondence Address: SEYFARTH SHAW LLP, 131 S. DEARBORN ST., SUITE 2400, CHICAGO, IL, 60603-5803, US

(73) Assignee: Helen of Troy Limited

(21) Appl. No.: 12/001,327

(22) Filed: Dec. 10, 2007

Related U.S. Application Data
(62) Division of application No. 11/366,048, filed on Mar. 1, 2006.

(51) Int. Cl. B27B 21/02

(52) U.S. Cl. 30/508

(57) ABSTRACT

A hand saw including a housing defining a channel. The channel is adapted to receive a blade having a top edge, a bottom edge and two sides. The hand saw includes at least one bias member positioned adjacent to one of the sides of the blade in the housing and a lever coupled to the bias member. The lever is movable between an open position where the bias member is disengaged from the blade, and a closed position, where the bias member substantially engages at least one of the sides of the blade to secure the blade in the housing.

### BACKGROUND

There are many different types of tools for cutting materials. Certain tools are designed to cut specific materials. For example, certain types of saws are used to cut wood and other types are used to cut metal or other materials. One type of saw used to cut metal is a hacksaw. Hacksaws are typically used to cut straight lines in metal and employ a fine toothed saw blade. Smaller hacksaws or mini-hacksaws are used to saw items in hard to reach places or areas having limited space. Hacksaw blades tend to be replaced frequently because the blades break or become dull after repeated use. In most cases, a user has to unscrew a broken blade from a frame in order to replace it, which takes significant time and effort.

Accordingly, there is a need for an improved hacksaw which securely holds a blade and enables a user to quickly and easily remove and replace the blade.

### SUMMARY

The present invention is directed to a hand saw, and more specifically to a hacksaw including a housing and a lever movably connected to the housing, where the lever is movable between an open position and a closed position to release and secure a blade in the housing.

One embodiment provides a hand saw including a housing defining a channel. The channel is adapted to receive a blade having a top edge, a bottom edge and two sides. The hand saw includes at least one bias member positioned adjacent to one of the sides of the blade in the housing and a lever coupled to the bias member. The lever is movable between an open position where the bias member is disengaged from the blade, and a closed position, where the bias member substantially engages at least one of the sides of the blade to secure the blade in the housing.

In an embodiment, the bias member includes at least one spring arm, where the spring arm is adapted to engage the blade to secure the blade in the housing.

In an embodiment, the hand saw includes a guide connected to the lever and positioned adjacent to the bias member. The guide contacts the spring arm to cause the spring arm to engage the blade when the lever is moved from the open position to the closed position.

In an embodiment, the hand saw includes a support plate positioned adjacent to the blade on a side of the blade opposite to the bias member, where the support plate engages the spring arm of the bias member.

In an embodiment, the hand saw includes a guide connected to the lever and positioned adjacent to the bias member. The guide contacts at least one of the spring arms to cause the spring arm to engage the blade when the lever is moved from the open position to the closed position.

In an embodiment, the bias member includes a plurality of spring arms, where one of the spring arms is adapted to engage the blade at a first location and at least one other of the spring arms is adapted to engage the blade at a second different location to secure the blade in the housing.

In an embodiment, the lever is rotatably connected to the bias member and is operable to rotate between the open position and the closed position.

Another embodiment provides a hand saw including a first member and a second member connected together, where the first and second members cooperate to define a channel. The channel is adapted to receive a blade which is positioned adjacent to the bias member in the channel and defines at least one opening. The hand saw includes a lever assembly positioned in the channel, where the lever assembly includes a lever movable between an open position and a closed position. The hand saw also includes a bias member coupled to the lever assembly, where the bias member includes at least one spring arm. When the lever is in the open position the spring arm is disengaged from the opening defined by the blade, and when the lever arm is in the closed position the spring arm is engaged with the opening in the blade to secure the blade.

In an embodiment, at least one of the first and second members includes a support arm, where the support arm engages at least a portion of the blade.

In an embodiment, the hand saw includes a guide connected to the lever assembly and positioned adjacent to the bias member. The guide contacts the spring arm to cause the spring arm to engage the opening defined by the blade when the lever is moved from the open position to the closed position.

In an embodiment, the hand saw includes a support plate positioned adjacent to the blade on a side of the blade opposite to the bias member. The support plate engages the spring arm of the bias member.

In an embodiment, the bias member includes a plurality of spring arms, where one of the spring arms is adapted to engage the opening defined by the blade at a first location and at least one other of the spring arms is adapted to engage the blade at a second different location to secure the blade in the housing.

In an embodiment, the hand saw includes a guide connected to the lever assembly and positioned adjacent to the bias member. The guide contacts at least one of the spring arms to cause the spring arm to engage the opening defined by the blade when the lever is moved from the open position to the closed position.

In an embodiment, the hand saw includes a support plate positioned adjacent to the blade on a side of the blade opposite to the bias member, where the support plate engages at least one of the spring arms of the bias member.

In an embodiment, the lever is rotatably connected to the bias member and is operable to rotate between the open position and the closed position.

A further embodiment provides a hand saw including a housing defining a channel. The channel is adapted to receive a blade having a first side and a second side. The hand saw includes a lever pivotably connected to the housing and movable between a first position and a second position, a first wedge coupled to the lever and a second wedge positioned adjacent to the first wedge. The second wedge is movably connected to the housing so that when the lever is in the open position, the blade is not secured in the housing, and when the lever is in the closed position, the first wedge contacts the second wedge to cause the second wedge to engage the first side of the blade and the second side of the blade to contact the housing to secure the blade in the housing.

In an embodiment, the hand saw includes a spring positioned in the housing. The spring contacts the second side of the blade and biases the blade towards the second wedge to secure the blade in the housing.

In an embodiment, each of the first and second wedges includes at least one angled surface.

In an embodiment, the first wedge includes an arm engageable by the lever, where when the lever is moved to the open position, the lever engages the arm and causes the arm and the first wedge to move upwardly and away from the second wedge, and disengage the second wedge from the blade.

It is therefore an advantage of the present invention to provide a hand saw having housing and a blade which is easily and quickly removable and replaceable in the housing.

Another advantage of the present invention is to provide a hand saw which securely holds a blade.

Other objects, features and advantages of the invention will be apparent from the following detailed disclosure, taken in conjunction with the accompanying sheets of drawings, wherein like numerals refer to like parts, elements, components, steps and processes.

### DESCRIPTION OF THE FIGURES

FIG. 1 is an elevation view of one embodiment of the hacksaw of the present invention.

FIG. 2 is an exploded perspective view of the hacksaw of FIG. 1.

FIG. 3A is an elevation view of the bias member, the guide and the lever of the hacksaw of FIG. 1 where the housing is removed from the hacksaw and the lever is in the open position.

FIG. 3B is a cross-section view taken substantially along the line 3B-3B shown in FIG. 3A.

FIG. 4A is an elevation view of the bias member, the guide and the lever of the hacksaw of FIG. 1 where the housing is removed from the hacksaw and the lever is in the closed position.

FIG. 4B is a cross-section view taken substantially along the line 4B-4B shown in FIG. 4A.

FIG. 5A is a partial perspective view illustrating how the spring arm engages the blade.

FIG. 5B is a cross-section view taken substantially along the line 5B-5B shown in FIG. 5A.

FIG. 6 is a side view of the first member of the housing of the embodiment illustrated in FIG. 2.

FIG. 7 is a side view of the second member of the housing of the embodiment illustrated in FIG. 2.

FIG. 8A is a partial perspective view of another embodiment of the hacksaw where the lever is in the closed position.

FIG. 8B is an end view of the embodiment of the hacksaw of FIG. 8A.

FIG. 9A is a partial perspective view of the embodiment of FIG. 7A where the lever is in the open position.

FIG. 9B is an enlarged partial side view of the lever of FIG. 9A where the lever engages the first wedge.

### DETAILED DESCRIPTION

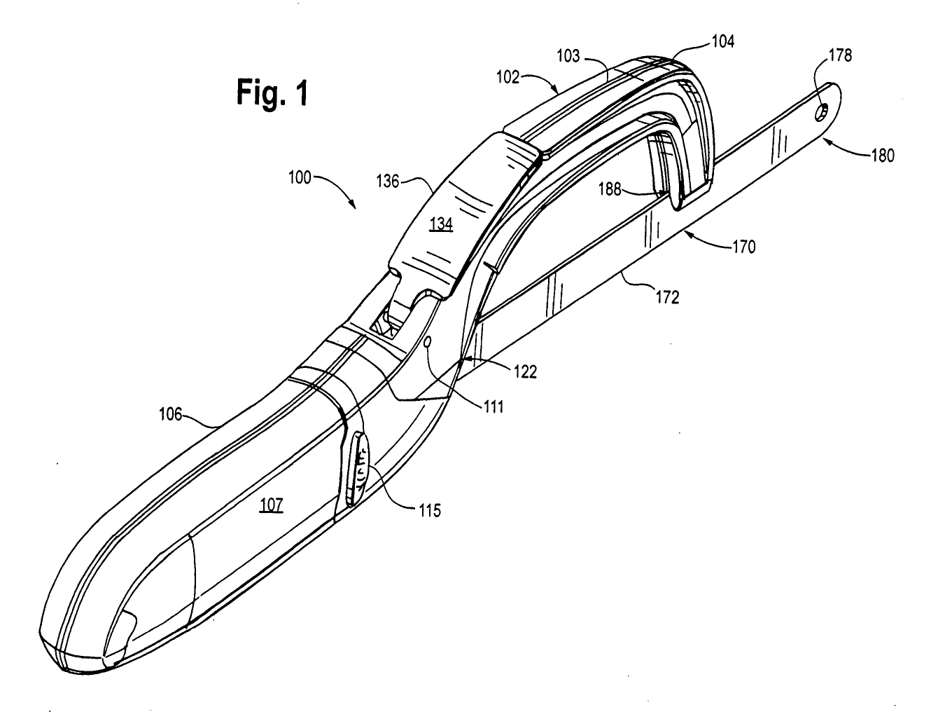

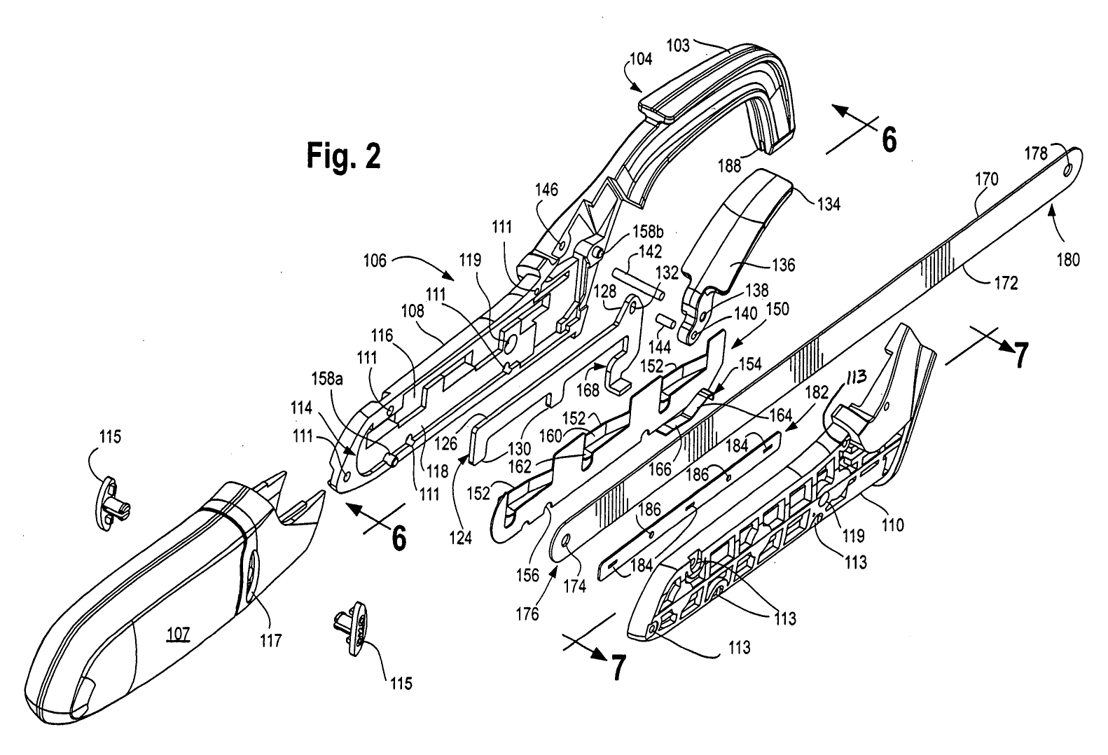

Referring to the figures, one embodiment of a hand saw of the present invention is illustrated where the hand saw is a hacksaw 100 including a housing 102 having a generally front portion 104 and a generally straight rear portion 106. The housing 102 is formed by joining a first member 108 including a U-shaped front end 103 and a second member 110 which are snapped together or connected together in any suitable manner. Suitable connectors such as screws are inserted into first and second openings 111 and 113 respectively to secure the first and second members 108 and 110 together. In the illustrated embodiment, a grip 107 is used to help secure the first and second members together. As shown in FIGS. 1 and 2, the grip 107 fits or slides over the end 106 of the housing to secure the first and second members 108 and 110. T-shaped connectors 115 are inserted through grip openings 117 defined by the grip 107 and engage receptacles 119 defined by the first and second members to secure the grip 107 to the housing 102. As shown in FIG. 2, the connectors 115 may include a company logo or any other suitable text, shape or image. It should be appreciated that any suitable connector or connectors may be used to secure the grip to the housing. It should also be appreciated that any suitable connector or connection method can be used to secure the first and second members of the housing together.

In an embodiment, the housing 102, and more specifically, the first and second members 108, 110 are manufactured of steel or any other suitable material or materials. The first member 108 defines a groove 114. The groove 114 includes a first slot 116 and a second slot 118 and are defined by the rear portion 106 of the housing 102. The second member 110 defines a third slot 120 as shown in FIG. 7, which has a size and shape which corresponds to the size and shape of the blade 170 as discussed below. When the first and second members 108, 110 are joined or connected together a channel 122 is defined which holds the various components or parts of the hand saw 100.

In the illustrated embodiment, a guide or deflector 124 is positioned in the first slot 116 defined by the first member 108 of the housing 102. The guide 124 includes a generally straight planar portion 126 having a semicircular portion 128 extending from one side and a plurality of spaced apart tabs 130 extending from the opposite side. The semicircular portion 128 of the guide 124 defines a guide opening or hole 132.

A lever or handle 134 is coupled to the guide 124. The lever 134 includes a curved grip portion 136 which corresponds to the curvature of the front portion of the housing and defines a first lever opening 138 and a second lever opening 140. The first lever opening 138 receives a first pin 142. One end of the first pin 142 is inserted through the first lever opening 138 and into the first housing opening 146. The other end of the first pin 142 is inserted into the second housing opening 148. The first pin 142 is held in place when the first member 108 and second member 110 of the housing 100 are connected together. The lever 134 moves and rotates about the axis defined by the first pin 142. The lever 134 is coupled to the guide 124 using a second pin 144. One end of the second pin 144 is inserted into the second lever opening 140 defined by the lever 134 and the other end of the second pin 144 is inserted into the guide opening 132. The second pin 144 causes the guide 124 to move forward and backward within the first slot 116 when the lever 134 is moved between an open and a closed position as described below.

In the illustrated embodiment, a bias member, securing member or holder 150 is positioned in the second slot 118 defined by the first member 108. The securing member 150 is a generally planar member which includes a plurality of spring arms 152 and a guide flange 154, and defines a pair of clearance openings 156. The securing member 150 also defines a recess 157 which is formed to mate with the front protrusion 158a on the first member 108. At least a portion of the protrusion 158a extends through the recess 156. The first member 108 also includes a second protrusion 158b which each engage corresponding receptacles 159a and 159b on the second member 110 to help hold and secure the first and second members together. In another embodiment, the lever 134 is connected to the bias member or securing member and causes the bias member to move back and forth within the channel 122.

Each of the spring arms 152 includes an elongated planar portion 160 and a planar finger 162 which is transverse to and extends away from the planar portion. As shown in the figures, the fingers 162 of the spring arms 152 extend away from the guide 124. The tabs 130 of the guide 124 are positioned to move along the inside surface of the planar portions 160 of the spring arms 152 to cause the spring arms to deflect or move generally inwardly when the lever 134 is moved to the closed position. The guide flange 154 includes a straight portion 164 and an angled portion 166. The guide flange 168 presses on straight portion 164 in the same way that one of the tabs 120 presses on the planar portion 160 of the spring arms. Guide flange 154 places an upward force on the blade 170 urging the blade into a support channel 188 to help secure the blade 170.

The guide 124 includes a guide plate, 168 which initially is in an upper position adjacent to the angled portion 166 of the guide flange 154 when the lever 134 is in the open position. When the lever 134 is moved to the closed position the guide 124 moves toward the rear portion 106 of the housing 102 thereby causing the guide plate 168 to move downwardly along the angled portion 166 of the guide flange 154 and then along the straight portion of the guide flange 168 when the lever 134 is in the closed position.

A generally elongated blade 170 is inserted into the channel 122 of the housing 102 and is positioned between the securing member 150 and the second member 110 of the housing 102. Specifically, the third slot 120 defined by the second member 110 of the housing 102 has a size and shape which corresponds to the size and shape of the blade 170. The blade 170 is interchangeable and may be replaced with any suitable blade having a size and shape which corresponds to the size and shape of the channel defined by the housing 102. In the illustrated embodiment, the blade 170 includes a serrated edge 172 which defines a plurality of teeth which cut through metal or any other suitable material. It should be appreciated that the blade may have a single serrated edge or a plurality of serrated edges. It should also be appreciated that the teeth of the blade may be of any suitable size and shape. In the illustrated embodiment, the blade 170 defines a first blade opening 174 and a first end 176 and a second blade opening 178 and a second end 180. The first and second blade openings 174, 178 have a size and shape which corresponds to the size and shape of the fingers 162 of the spring arms 152. Thus, either end of the blade 170 may be inserted into the channel defined by the housing 102 to secure the blade to the housing 102. The blade is manufactured of steel. It should be appreciated that the blade may be manufactured using any suitable material or materials.

In one embodiment, a support plate 182 is positioned between the blade 170 and the second member 110 of the housing 102. The support plate 182 is a generally elongated planar plate which defines a plurality of first plate openings 184 having a size and shape which corresponds to the size and shape of the fingers of the spring arms. The support plate 182 defines connector openings 186 which enable the support plate to be secured to the second member 110 of the housing 102 using suitable connectors, such as screws. The support plate 182 is positioned so that the plate openings receive at least a portion of one or more of the fingers 162 of the spring arms 152 which extend through the blade 170. The support plate 182 supports the fingers 162 of the spring arms 152 and minimizes the stresses on the fingers of the spring arms during use of the hand saw 100. In the illustrated embodiment the support plate is a separate part or piece which is positioned in the channel 122 defined by the housing 102. In another embodiment, the support plate 182 is integrally formed with the second housing 110. It should be appreciated that the support plate may be made out of steel or any suitable material or materials.

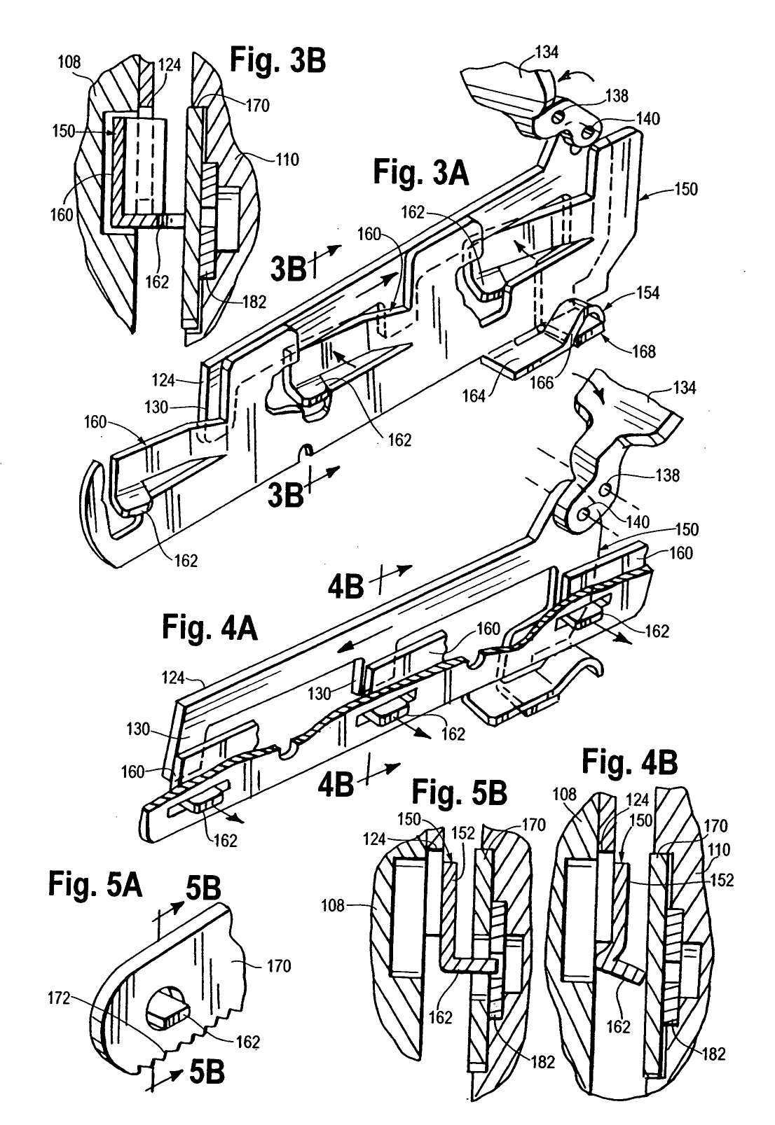

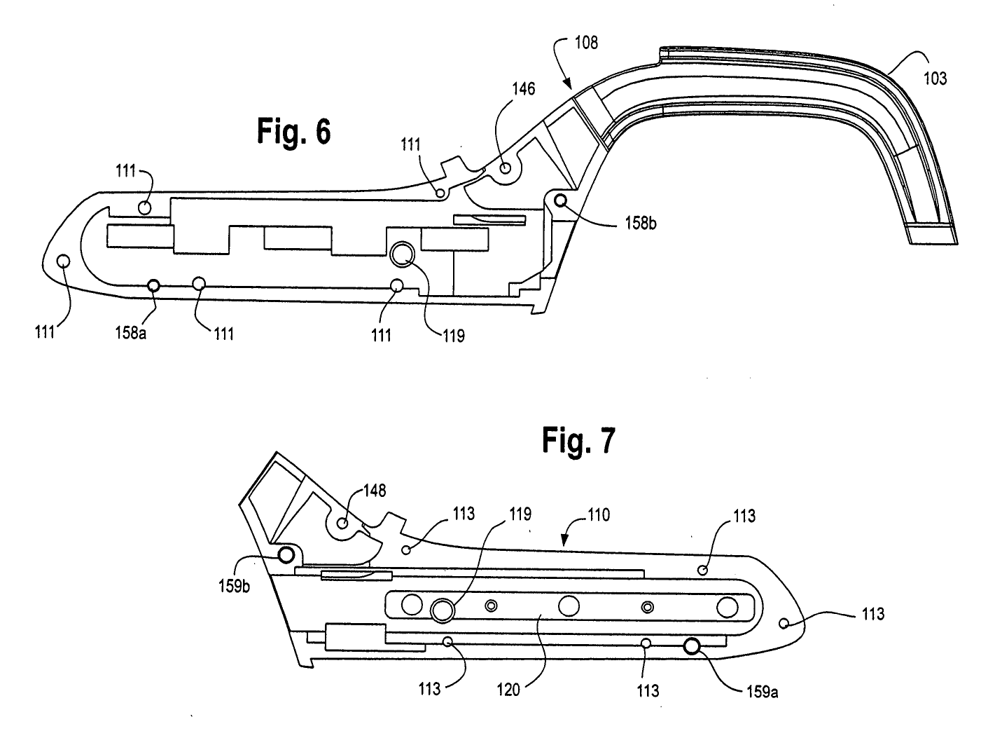

In operation, to insert a blade 170 or replace a blade secured in the housing 102, the lever 134 is moved to the open position as shown in FIGS. 3A and 3B. When the lever 134 is moved to the open position, the lever pulls or moves the guide 124 forward or towards the front portion 104 of the housing 102. The tabs 130 of the guide 124 move forward along the spring arms 152 and thereby release the inward pressure on the spring arms. The spring arms 152, and more specifically, the fingers 162 of the spring arms move away from and out of engagement with one of the blade openings 174, 178. The blade 170 is now unsecured from the housing 102. The blade 170 is removed and replaced with a new blade which is inserted into the channel 122 defined by the housing 102.

The lever 134 is moved to the closed position, as shown in FIGS. 4A and 4B. As the lever 134 moves to the closed position, it causes the guide 124 to move rearwardly or towards the rear portion 106 of the housing 102. This causes the tabs 130 of the guide 124 to move along the inside surface of the spring arms 152 toward the ends of the spring arms including the fingers 162. The tabs 130 thereby contact and push the spring arms 152 towards the blade 170. If the blade 170, and more specifically, one of the blade openings 174, 178 is positioned adjacent to one of the fingers 162 of the spring arms 152, the finger is received by the blade opening 174 or 178 and the corresponding plate opening 184 of the support plate 182. If the blade opening 174 or 178 is not aligned with one of the fingers 162 of the spring arms 152, the user moves the blade 170 within the housing 102 until the blade opening 174 or 178 engages one of the fingers 162 of the spring arms 152 as shown in FIGS. 5A and 5B. It should be appreciated that the rearward blade opening may engage any one of the spring arms 152 depending upon the desired length of the blade 170 to be extended from the housing 102. Thus, the length of the blade 170 needed to cut or saw an item may be adjusted by engaging the rearward blade opening 174 or 178 with different fingers 162 of the spring arms 152.

The front portion 104 of the housing 102 defines a support channel 188 which corresponds to the width of the blade 170. The support channel 188 is sized to snugly fit the blade 170 to support the front portion of the blade.

When the lever 134 is in the closed position, the blade 170 is secured in the housing 102 and the hand saw 100 can be used to saw or cut one or more items such as a piece of metal. The above process is repeated to replace the blade with a new blade or different blade.

Referring to FIGS. 1, 2, 8A, 8B, 9A and 9B, another embodiment of the hand saw is illustrated where the hand saw 100 includes the housing 102 formed by the first and second members 108 and 110 as described above. A lever or handle 200 is rotatably connected to the housing 102 using a pin or post 202 which is connected at one end to the first member 108 of the housing 102 and the opposite end of the pin 202 is inserted through an opening defined by the lever 200 and into a corresponding opening (not shown) defined by the second member 110 of the housing 102. The first and second members 108 and 110 of the housing 102 are connected together to secure the pin 202 in the housing. Similar to above, the housing 102 defines a channel (not shown) for receiving a blade 170. Specifically, the rear portion of the housing defines a first channel 204 for receiving one end of the blade and the front portion 104 of the housing 102 defines a second channel 206 sized to receive an edge of the blade 170 to support the front portion of the blade.

In this embodiment, a first wedge 208 having an L-shaped arm extending generally upwardly from the first wedge is movably connected to the housing 102 and positioned adjacent to the lever 200. The first wedge 208 defines an angled surface 212. A second wedge 214 is movably connected in the housing 102 and defines an angled surface 216 which is adjacent to the angled surface 212 of the first wedge 208. The second wedge 214 moves in a generally horizontal or side-to-side direction. The rear portion of the blade 170 is inserted into the channel defined by the rear portion of the housing and is positioned adjacent to the flat surface of the second wedge 214. A spring member 218 is movably connected in the housing 102 and is positioned between the blade 170 and the second member 110 of the housing. In an another embodiment, the spring member 218 is connected to or integrally formed with the second member of the housing 110. In the illustrated embodiment, the spring member 218 is biased inwardly against the blade 170 and moves horizontally or laterally within the housing.

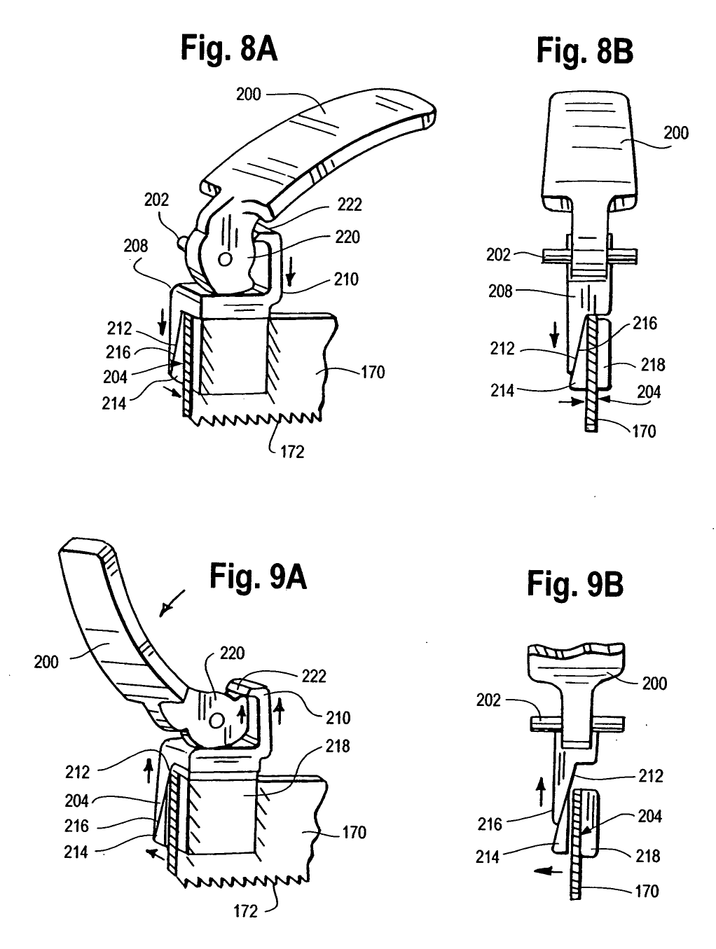

When the lever 200 is in the open position, as shown in FIGS. 9A and 9B, the angled surface 212 of the first wedge 208 is generally applying no pressure to the angled surface 216 of the second wedge 214. In this position, a blade 170 can be inserted into the channel 122 defined by the rear portion 106 of the housing 102 or a blade 170 can be removed from the housing 102 and replaced with a new or different blade. To secure a blade in the housing 102, the lever 200 is moved to the closed position or the position substantially flush with the housing, as shown in FIGS. 8A and 8B. Moving the lever 200 to the closed position causes a cam portion 220 of the lever to push downwardly against the top surface of the first wedge as shown in FIG. 8A. The first wedge 208 moves downwardly and causes the angled surface 212 of the first wedge 208 to contact the angled surface 216 of the second wedge 214. As the angled surface 212 of the first wedge 208 pushes against the angled surface 216 of the second wedge 214, the second wedge moves laterally inwardly against the blade 170. The inward force of the second wedge 214 and the spring member 218 against opposing sides of the blade 170 secure the blade within the housing 102. The spring member 218 moves laterally within the housing 102 to accommodate different sized blades having different thicknesses.

To remove a blade 170 from the housing 102, the lever 200 is moved to the open position shown in FIG. 9A. Specifically, the lever 200 is rotated away from the housing 102 causing the cam portion 220 of the lever to engage a lip 222 of the arm 210 of the first wedge 208. The cam portion 220 of the lever 200 contacts the lip 222 of the arm and causes the arm 210 and the first wedge 208 to move generally upwardly within the housing 102. This causes the angled surface 212 of the first wedge 208 to move away from the angled surface 216 of the second wedge 214 thereby releasing the pressure of the first wedge from the second wedge. The second wedge 214 moves outwardly away from the blade 170 as the first wedge 208 moves upwardly within the housing 102. This releases the pressure, or at least reduces the pressure, of the second wedge 214 against the blade 170 thereby allowing the blade to be removed from the housing. The above steps can be repeated to move and/or replace blades in the housing.

Each of the above components or parts of the hand saw are made of steel or a similar durable material. It should be appreciated that any suitable material or materials may be used to manufacture the components of the hand saw.

As described above, in an embodiment, the grip 107 is attached to at least a portion of the housing such as the rear portion of the housing to enable a user to securing hold the hand saw during use. In an embodiment, the grip 107 is made of a suitable non-slip or non-skid material, such as rubber. It should be appreciated that the grip may be made out of any suitable material or materials.

While the present invention is described in connection with what is presently considered to be the most practical and preferred embodiments, it should be appreciated that the invention is not limited to the disclosed embodiments, and is intended to cover various modifications and equivalent arrangements included within the spirit and scope of the claims. Modifications and variations in the present invention may be made without departing from the novel aspects of the invention as defined in the claims, and this application is limited only by the scope of the claims.

1-15. (canceled)

16. A handsaw comprising:
a housing defining a channel, said channel adapted to receive a blade having a first side and a second side;
a lever pivotably connected to said housing and movable between a first position and a second position;
a first wedge coupled to said lever; and
a second wedge positioned adjacent to said first wedge, said second wedge being movably connected to said housing,
wherein when said lever is in the open position, said blade is not secured in said housing, and when said lever is in the closed position, said first wedge contacts said second wedge to cause said second wedge to engage the first side of said blade and said second side of said blade to contact said housing to secure the blade in the housing.

17. The hand saw of claim 16, which includes a spring positioned in the housing, said spring contacts the second side of said blade and biases said blade towards said second wedge to secure the blade in the housing.

18. The hand saw of claim 16, wherein each of said first and second wedges include at least one angled surface.

19. The hand saw of claim 16, wherein said first wedge includes an arm engageable by said lever, wherein when said lever is moved to the open position, said lever
engages said arm and causes said arm and said first wedge to move upwardly and away from said second wedge, and disengage said second wedge from said blade.
